(19) United States
(12) Patent Application Publication
(10) Pub. No.: US 2025/0324141 A1
(43) Pub. Date: Oct. 16, 2025

(54) SIGNALING CONFIGURATION UPDATES USING SERVICE DESCRIPTIONS FOR STREAMED MEDIA DATA

(71) Applicant: QUALCOMM Incorporated, San Diego, CA (US)

(72) Inventors: Thomas Stockhammer, Bergen (DE); Imed Bouazizi, Celina, TX (US)

(21) Appl. No.: 19/174,599

(22) Filed: Apr. 9, 2025

Related U.S. Application Data
(60) Provisional application No. 63/634,814, filed on Apr. 16, 2024.

(51) Int. Cl. H04N 21/6373; H04L 65/80; H04N 21/83

(52) U.S. Cl. CPC H04N 21/6373; H04L 65/80; H04N 21/83

(57) ABSTRACT

An example device for retrieving media data includes: a memory configured to store media data of a media presentation; and a processing system comprising one or more processors implemented in circuitry, the processing system being configured to: receive an event message of the media presentation, the event message including data representing a media presentation time at which a service description for the media presentation is to be activated; receive the media data of the media presentation; and in response to receiving the event message of the media presentation including the data representing the media presentation time at which the service description is to be activated, activate the service description at the media presentation time and present the media data according to the service description.

This application claims the benefit of U.S. Provisional Application No. 63/634,814, filed Apr. 16, 2024, the entire contents of which are hereby incorporated by reference.

### TECHNICAL FIELD

This disclosure relates to transport of encoded media data.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, digital media players, video gaming devices, video game consoles, cellular or satellite radio telephones, video teleconferencing devices, and the like. Digital video devices implement video compression techniques, such as those described in the standards defined by MPEG-2, MPEG-4, ITU-T H.263 or ITU-T H.264/MPEG-4, Part 10, Advanced Video Coding (AVC), ITU-T H.265 (also referred to as High Efficiency Video Coding (HEVC)), and extensions of such standards, to transmit and receive digital video information more efficiently.

After media data has been encoded, the media data may be packetized for transmission or storage. The media data may be assembled into a video file conforming to any of a variety of standards, such as the International Organization for Standardization (ISO) base media file format and extensions thereof, such as AVC.

### SUMMARY

In general, this disclosure describes techniques for signaling configuration updates for a media streaming client, such as a Dynamic Adaptive Streaming over HTTP (DASH) client. The configuration updates may be signaled in a Service Description, which may be included in or indicated by DASH Event messages. Events, such as DASH Events, may be indicated in a manifest file, such as a media presentation description (MPD). The configuration updates may correspond to data used for DASH.js. Per techniques of this disclosure, service descriptions may be used to dynamically change configuration for streaming according to, e.g., DASH, rather than having configuration changes being limited only to at Period boundaries or being static throughout a media presentation.

In one example, a method of retrieving media data includes: receiving an event message of a media presentation, the event message including data representing a media presentation time at which a service description for the media presentation is to be activated; receiving media data of the media presentation; and in response to receiving the event message of the media presentation including the data representing the media presentation time at which the service description is to be activated, activating the service description at the media presentation time and presenting the media data according to the service description.

In another example, a device for retrieving media data includes: a memory configured to store media data of a media presentation; and a processing system comprising one or more processors implemented in circuitry, the processing system being configured to: receive an event message of the media presentation, the event message including data representing a media presentation time at which a service description for the media presentation is to be activated; receive the media data of the media presentation; and in response to receiving the event message of the media presentation including the data representing the media presentation time at which the service description is to be activated, activate the service description at the media presentation time and present the media data according to the service description.

In another example, a device for retrieving media data includes: means for receiving an event message of a media presentation, the event message including data representing a media presentation time at which a service description for the media presentation is to be activated; means for receiving media data of the media presentation; and means for activating the service description at the media presentation time and means for presenting the media data according to the service description in response to receiving the event message including the data representing the media presentation time at which the service description is to be activated.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a block diagram illustrating an example system that implements techniques for streaming media data over a network.

FIG. 2 is a block diagram illustrating an example set of components of a retrieval unit.

FIG. 3 is a conceptual diagram illustrating elements of example multimedia content.

FIG. 4 is a block diagram illustrating elements of an example video file, which may correspond to a segment of a representation.

FIG. 5 is a block diagram illustrating an example media streaming application per techniques of this disclosure.

FIG. 6 is a flowchart illustrating an example method of using a service description for media presentation according to techniques of this disclosure.

FIG. 7 is a flowchart illustrating an example method of receiving and using a service description according to techniques of this disclosure.

### DETAILED DESCRIPTION

In general, this disclosure describes techniques for signaling configuration updates for a media streaming client, such as a Dynamic Adaptive Streaming over HTTP (DASH) client. The configuration updates may be signaled in a Service Description, which may be included in or indicated by DASH Event messages. Events, such as DASH Events, may be indicated in a manifest file, such as a media presentation description (MPD). The configuration updates may correspond to data used for DASH.js.

The techniques of this disclosure may be applied to video files conforming to video data encapsulated according to any of ISO base media file format, Scalable Video Coding (SVC) file format, Advanced Video Coding (AVC) file format, Third Generation Partnership Project (3GPP) file format, and/or Multiview Video Coding (MVC) file format, or other similar video file formats.

In HTTP streaming, such as Dynamic Adaptive Streaming over HTTP (DASH), frequently used operations include HEAD, GET, and partial GET. The HEAD operation retrieves a header of a file associated with a given uniform resource locator (URL) or uniform resource name (URN), without retrieving a payload associated with the URL or URN. The GET operation retrieves a whole file associated with a given URL or URN. The partial GET operation receives a byte range as an input parameter and retrieves a continuous number of bytes of a file, where the number of bytes correspond to the received byte range. Thus, movie fragments may be provided for HTTP streaming, because a partial GET operation can get one or more individual movie fragments. In a movie fragment, there can be several track fragments of different tracks. In HTTP streaming, a media presentation may be a structured collection of data that is accessible to the client. The client may request and download media data information to present a streaming service to a user.

In the example of streaming 3GPP data using HTTP streaming, there may be multiple representations for video and/or audio data of multimedia content. As explained below, different representations may correspond to different coding characteristics (e.g., different profiles or levels of a video coding standard), different coding standards or extensions of coding standards (such as multiview and/or scalable extensions), or different bitrates. The manifest of such representations may be defined in a Media Presentation Description (MPD) data structure. A media presentation may correspond to a structured collection of data that is accessible to an HTTP streaming client device. The HTTP streaming client device may request and download media data information to present a streaming service to a user of the client device. A media presentation may be described in the MPD data structure, which may include updates of the MPD.

A media presentation may contain a sequence of one or more Periods. Each period may extend until the start of the next Period, or until the end of the media presentation, in the case of the last period. Each period may contain one or more representations for the same media content. A representation may be one of a number of alternative encoded versions of audio, video, timed text, or other such data. The representations may differ by encoding types, e.g., by bitrate, resolution, and/or codec for video data and bitrate, language, and/or codec for audio data. The term representation may be used to refer to a section of encoded audio or video data corresponding to a particular period of the multimedia content and encoded in a particular way.

Representations of a particular period may be assigned to a group indicated by an attribute in the MPD indicative of an adaptation set to which the representations belong. Representations in the same adaptation set are generally considered alternatives to each other, in that a client device can dynamically and seamlessly switch between these representations, e.g., to perform bandwidth adaptation. For example, each representation of video data for a particular period may be assigned to the same adaptation set, such that any of the representations may be selected for decoding to present media data, such as video data or audio data, of the multimedia content for the corresponding period. The media content within one period may be represented by either one representation from group 0, if present, or the combination of at most one representation from each non-zero group, in some examples. Timing data for each representation of a period may be expressed relative to the start time of the period.

A representation may include one or more segments. Each representation may include an initialization segment, or each segment of a representation may be self-initializing. When present, the initialization segment may contain initialization information for accessing the representation. In general, the initialization segment does not contain media data. A segment may be uniquely referenced by an identifier, such as a uniform resource locator (URL), uniform resource name (URN), or uniform resource identifier (URI). The MPD may provide the identifiers for each segment. In some examples, the MPD may also provide byte ranges in the form of a range attribute, which may correspond to the data for a segment within a file accessible by the URL, URN, or URI.

Different representations may be selected for substantially simultaneous retrieval for different types of media data. For example, a client device may select an audio representation, a video representation, and a timed text representation from which to retrieve segments. In some examples, the client device may select particular adaptation sets for performing bandwidth adaptation. That is, the client device may select an adaptation set including video representations, an adaptation set including audio representations, and/or an adaptation set including timed text. Alternatively, the client device may select adaptation sets for certain types of media (e.g., video), and directly select representations for other types of media (e.g., audio and/or timed text).

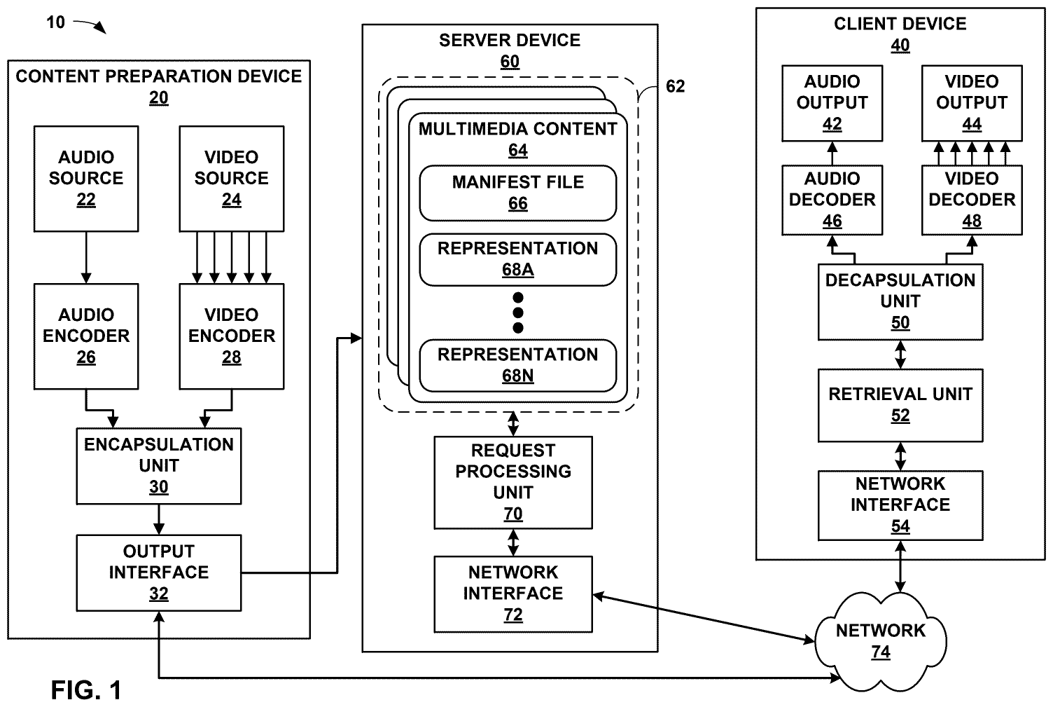

FIG. 1 is a block diagram illustrating an example system 10 that implements techniques for streaming media data over a network. In this example, system 10 includes content preparation device 20, server device 60, and client device 40. Client device 40 and server device 60 are communicatively coupled by network 74, which may comprise the Internet. In some examples, content preparation device 20 and server device 60 may also be coupled by network 74 or another network, or may be directly communicatively coupled. In some examples, content preparation device 20 and server device 60 may comprise the same device.

Content preparation device 20, in the example of FIG. 1, comprises audio source 22 and video source 24. Audio source 22 may comprise, for example, a microphone that produces electrical signals representative of captured audio data to be encoded by audio encoder 26. Alternatively, audio source 22 may comprise a storage medium storing previously recorded audio data, an audio data generator such as a computerized synthesizer, or any other source of audio data. Video source 24 may comprise a video camera that produces video data to be encoded by video encoder 28, a storage medium encoded with previously recorded video data, a video data generation unit such as a computer graphics source, or any other source of video data. Content preparation device 20 is not necessarily communicatively coupled to server device 60 in all examples, but may store multimedia content to a separate medium that is read by server device 60.

Raw audio and video data may comprise analog or digital data. Analog data may be digitized before being encoded by audio encoder 26 and/or video encoder 28. Audio source 22 may obtain audio data from a speaking participant while the speaking participant is speaking, and video source 24 may simultaneously obtain video data of the speaking participant. In other examples, audio source 22 may comprise a computer-readable storage medium comprising stored audio data, and video source 24 may comprise a computer-readable storage medium comprising stored video data. In this manner, the techniques described in this disclosure may be applied to live, streaming, real-time audio and video data or to archived, pre-recorded audio and video data.

Audio frames that correspond to video frames are generally audio frames containing audio data that was captured (or generated) by audio source 22 contemporaneously with video data captured (or generated) by video source 24 that is contained within the video frames. For example, while a speaking participant generally produces audio data by speaking, audio source 22 captures the audio data, and video source 24 captures video data of the speaking participant at the same time, that is, while audio source 22 is capturing the audio data. Hence, an audio frame may temporally correspond to one or more particular video frames. Accordingly, an audio frame corresponding to a video frame generally corresponds to a situation in which audio data and video data were captured at the same time and for which an audio frame and a video frame comprise, respectively, the audio data and the video data that was captured at the same time.

In some examples, audio encoder 26 may encode a timestamp in each encoded audio frame that represents a time at which the audio data for the encoded audio frame was recorded, and similarly, video encoder 28 may encode a timestamp in each encoded video frame that represents a time at which the video data for an encoded video frame was recorded. In such examples, an audio frame corresponding to a video frame may comprise an audio frame comprising a timestamp and a video frame comprising the same timestamp. Content preparation device 20 may include an internal clock from which audio encoder 26 and/or video encoder 28 may generate the timestamps, or that audio source 22 and video source 24 may use to associate audio and video data, respectively, with a timestamp.

In some examples, audio source 22 may send data to audio encoder 26 corresponding to a time at which audio data was recorded, and video source 24 may send data to video encoder 28 corresponding to a time at which video data was recorded. In some examples, audio encoder 26 may encode a sequence identifier in encoded audio data to indicate a relative temporal ordering of encoded audio data but without necessarily indicating an absolute time at which the audio data was recorded, and similarly, video encoder 28 may also use sequence identifiers to indicate a relative temporal ordering of encoded video data. Similarly, in some examples, a sequence identifier may be mapped or otherwise correlated with a timestamp.

Audio encoder 26 generally produces a stream of encoded audio data, while video encoder 28 produces a stream of encoded video data. Each individual stream of data (whether audio or video) may be referred to as an elementary stream. An elementary stream is a single, digitally coded (possibly compressed) component of a representation. For example, the coded video or audio part of the representation can be an elementary stream. An elementary stream may be converted into a packetized elementary stream (PES) before being encapsulated within a video file. Within the same representation, a stream ID may be used to distinguish the PES-packets belonging to one elementary stream from the other. The basic unit of data of an elementary stream is a packetized elementary stream (PES) packet. Thus, coded video data generally corresponds to elementary video streams. Similarly, audio data corresponds to one or more respective elementary streams.

Many video coding standards, such as ITU-T H.264/AVC and the upcoming High Efficiency Video Coding (HEVC) standard, define the syntax, semantics, and decoding process for error-free bitstreams, any of which conform to a certain profile or level. Video coding standards typically do not specify the encoder, but the encoder is tasked with guaranteeing that the generated bitstreams are standard-compliant for a decoder. In the context of video coding standards, a “profile” corresponds to a subset of algorithms, features, or tools and constraints that apply to them. As defined by the H.264 standard, for example, a “profile” is a subset of the entire bitstream syntax that is specified by the H.264 standard. A “level” corresponds to the limitations of the decoder resource consumption, such as, for example, decoder memory and computation, which are related to the resolution of the pictures, bit rate, and block processing rate. A profile may be signaled with a profile_idc (profile indicator) value, while a level may be signaled with a level_idc (level indicator) value.

The H.264 standard, for example, recognizes that, within the bounds imposed by the syntax of a given profile, it is still possible to require a large variation in the performance of encoders and decoders depending upon the values taken by syntax elements in the bitstream such as the specified size of the decoded pictures. The H.264 standard further recognizes that, in many applications, it is neither practical nor economical to implement a decoder capable of dealing with all hypothetical uses of the syntax within a particular profile. Accordingly, the H.264 standard defines a “level” as a specified set of constraints imposed on values of the syntax elements in the bitstream. These constraints may be simple limits on values. Alternatively, these constraints may take the form of constraints on arithmetic combinations of values (e.g., picture width multiplied by picture height multiplied by number of pictures decoded per second). The H.264 standard further provides that individual implementations may support a different level for each supported profile.

A decoder conforming to a profile ordinarily supports all the features defined in the profile. For example, as a coding feature, B-picture coding is not supported in the baseline profile of H.264/AVC but is supported in other profiles of H.264/AVC. A decoder conforming to a level should be capable of decoding any bitstream that does not require resources beyond the limitations defined in the level. Definitions of profiles and levels may be helpful for interpretability. For example, during video transmission, a pair of profile and level definitions may be negotiated and agreed for a whole transmission session. More specifically, in H.264/AVC, a level may define limitations on the number of macroblocks that need to be processed, decoded picture buffer (DPB) size, coded picture buffer (CPB) size, vertical motion vector range, maximum number of motion vectors per two consecutive MBs, and whether a B-block can have sub-macroblock partitions less than 8×8 pixels. In this manner, a decoder may determine whether the decoder is capable of properly decoding the bitstream.

In the example of FIG. 1, encapsulation unit 30 of content preparation device 20 receives elementary streams comprising coded video data from video encoder 28 and elementary streams comprising coded audio data from audio encoder 26. In some examples, video encoder 28 and audio encoder 26 may each include packetizers for forming PES packets from encoded data. In other examples, video encoder 28 and audio encoder 26 may each interface with respective packetizers for forming PES packets from encoded data. In still other examples, encapsulation unit 30 may include packetizers for forming PES packets from encoded audio and video data.

Video encoder 28 may encode video data of multimedia content in a variety of ways, to produce different representations of the multimedia content at various bitrates and with various characteristics, such as pixel resolutions, frame rates, conformance to various coding standards, conformance to various profiles and/or levels of profiles for various coding standards, representations having one or multiple views (e.g., for two-dimensional or three-dimensional playback), or other such characteristics. A representation, as used in this disclosure, may comprise one of audio data, video data, text data (e.g., for closed captions), or other such data. The representation may include an elementary stream, such as an audio elementary stream or a video elementary stream. Each PES packet may include a stream_id that identifies the elementary stream to which the PES packet belongs. Encapsulation unit 30 is responsible for assembling elementary streams into video files (e.g., segments) of various representations.

Encapsulation unit 30 receives PES packets for elementary streams of a representation from audio encoder 26 and video encoder 28 and forms corresponding network abstraction layer (NAL) units from the PES packets. Coded video segments may be organized into NAL units, which provide a “network-friendly” video representation addressing applications such as video telephony, storage, broadcast, or streaming. NAL units can be categorized to Video Coding Layer (VCL) NAL units and non-VCL NAL units. VCL units may contain the core compression engine and may include block, macroblock, and/or slice level data. Other NAL units may be non-VCL NAL units. In some examples, a coded picture in one time instance, normally presented as a primary coded picture, may be contained in an access unit, which may include one or more NAL units.

Non-VCL NAL units may include parameter set NAL units and SEI NAL units, among others. Parameter sets may contain sequence-level header information (in sequence parameter sets (SPS)) and the infrequently changing picture-level header information (in picture parameter sets (PPS)). With parameter sets (e.g., PPS and SPS), infrequently changing information need not to be repeated for each sequence or picture; hence, coding efficiency may be improved. Furthermore, the use of parameter sets may enable out-of-band transmission of the important header information, avoiding the need for redundant transmissions for error resilience. In out-of-band transmission examples, parameter set NAL units may be transmitted on a different channel than other NAL units, such as SEI NAL units.

Supplemental Enhancement Information (SEI) may contain information that is not necessary for decoding the coded pictures samples from VCL NAL units, but may assist in processes related to decoding, display, error resilience, and other purposes. SEI messages may be contained in non-VCL NAL units. SEI messages are the normative part of some standard specifications, and thus are not always mandatory for standard compliant decoder implementation. SEI messages may be sequence level SEI messages or picture level SEI messages. Some sequence level information may be contained in SEI messages, such as scalability information SEI messages in the example of SVC and view scalability information SEI messages in MVC. These example SEI messages may convey information on, e.g., extraction of operation points and characteristics of the operation points. In addition, encapsulation unit 30 may form a manifest file, such as a media presentation descriptor (MPD) that describes characteristics of the representations. Encapsulation unit 30 may format the MPD according to extensible markup language (XML).

Encapsulation unit 30 may provide data for one or more representations of multimedia content, along with the manifest file (e.g., the MPD) to output interface 32. Output interface 32 may comprise a network interface or an interface for writing to a storage medium, such as a universal serial bus (USB) interface, a CD or DVD writer or burner, an interface to magnetic or flash storage media, or other interfaces for storing or transmitting media data. Encapsulation unit 30 may provide data of each of the representations of multimedia content to output interface 32, which may send the data to server device 60 via network transmission or storage media. In the example of FIG. 1, server device 60 includes storage medium 62 that stores various multimedia contents 64, each including a respective manifest file 66 and one or more representations 68A-68N (representations 68). In some examples, output interface 32 may also send data directly to network 74.

In some examples, representations 68 may be separated into adaptation sets. That is, various subsets of representations 68 may include respective common sets of characteristics, such as codec, profile and level, resolution, number of views, file format for segments, text type information that may identify a language or other characteristics of text to be displayed with the representation and/or audio data to be decoded and presented, e.g., by speakers, camera angle information that may describe a camera angle or real-world camera perspective of a scene for representations in the adaptation set, rating information that describes content suitability for particular audiences, or the like.

Manifest file 66 may include data indicative of the subsets of representations 68 corresponding to particular adaptation sets, as well as common characteristics for the adaptation sets. Manifest file 66 may also include data representative of individual characteristics, such as bitrates, for individual representations of adaptation sets. In this manner, an adaptation set may provide for simplified network bandwidth adaptation. Representations in an adaptation set may be indicated using child elements of an adaptation set element of manifest file 66.

Server device 60 includes request processing unit 70 and network interface 72. In some examples, server device 60 may include a plurality of network interfaces. Furthermore, any or all of the features of server device 60 may be implemented on other devices of a content delivery network, such as routers, bridges, proxy devices, switches, or other devices. In some examples, intermediate devices of a content delivery network may cache data of multimedia content 64, and include components that conform substantially to those of server device 60. In general, network interface 72 is configured to send and receive data via network 74.

Request processing unit 70 is configured to receive network requests from client devices, such as client device 40, for data of storage medium 62. For example, request processing unit 70 may implement hypertext transfer protocol (HTTP) version 1.1, as described in RFC 2616, “Hypertext Transfer Protocol-HTTP/1.1,” by R. Fielding et al, Network Working Group, IETF, June 1999. That is, request processing unit 70 may be configured to receive HTTP GET or partial GET requests and provide data of multimedia content 64 in response to the requests. The requests may specify a segment of one of representations 68, e.g., using a URL of the segment. In some examples, the requests may also specify one or more byte ranges of the segment, thus comprising partial GET requests. Request processing unit 70 may further be configured to service HTTP HEAD requests to provide header data of a segment of one of representations 68. In any case, request processing unit 70 may be configured to process the requests to provide requested data to a requesting device, such as client device 40.

Additionally or alternatively, request processing unit 70 may be configured to deliver media data via a broadcast or multicast protocol, such as eMBMS. Content preparation device 20 may create DASH segments and/or sub-segments in substantially the same way as described, but server device 60 may deliver these segments or sub-segments using eMBMS or another broadcast or multicast network transport protocol. For example, request processing unit 70 may be configured to receive a multicast group join request from client device 40. That is, server device 60 may advertise an Internet protocol (IP) address associated with a multicast group to client devices, including client device 40, associated with particular media content (e.g., a broadcast of a live event). Client device 40, in turn, may submit a request to join the multicast group. This request may be propagated throughout network 74, e.g., routers making up network 74, such that the routers are caused to direct traffic destined for the IP address associated with the multicast group to subscribing client devices, such as client device 40.

As illustrated in the example of FIG. 1, multimedia content 64 includes manifest file 66, which may correspond to a media presentation description (MPD). Manifest file 66 may contain descriptions of different alternative representations 68 (e.g., video services with different qualities) and the description may include, e.g., codec information, a profile value, a level value, a bitrate, and other descriptive characteristics of representations 68. Client device 40 may retrieve the MPD of a media presentation to determine how to access segments of representations 68.

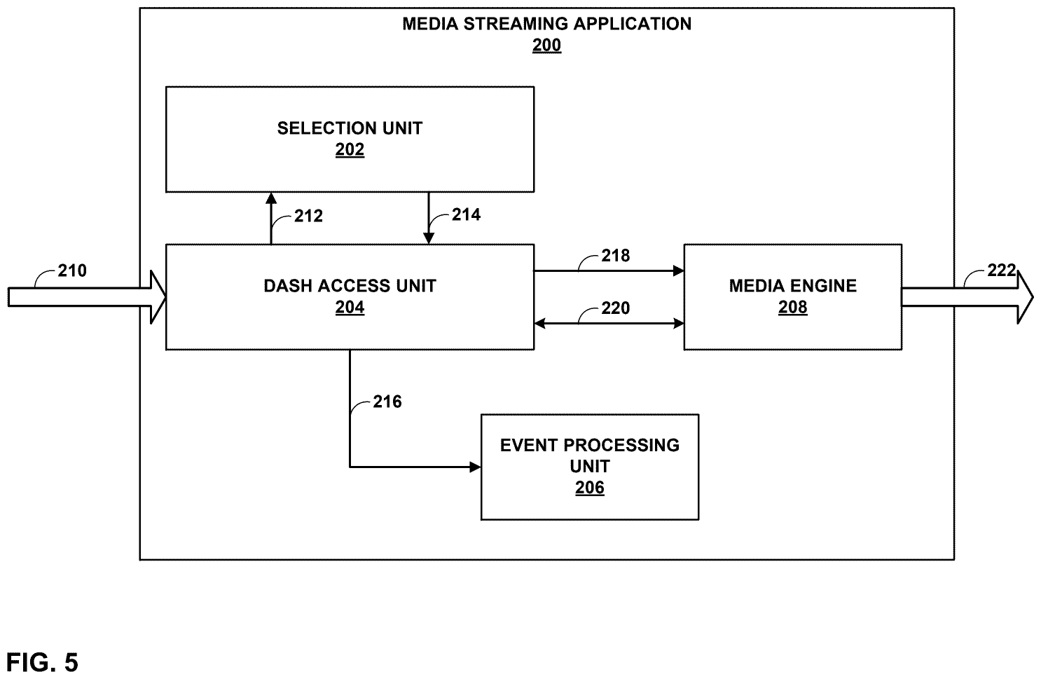

In particular, retrieval unit 52 may retrieve configuration data (not shown) of client device 40 to determine decoding capabilities of video decoder 48 and rendering capabilities of video output 44. The configuration data may also include any or all of a language preference selected by a user of client device 40, one or more camera perspectives corresponding to depth preferences set by the user of client device 40, and/or a rating preference selected by the user of client device 40. Retrieval unit 52 may comprise, for example, a web browser or a media client configured to submit HTTP GET and partial GET requests. Retrieval unit 52 may be or include a media streaming application, such as media streaming application 200 of FIG. 5, as discussed in greater detail below. Retrieval unit 52 may correspond to software instructions executed by one or more processors or processing units (not shown) of client device 40. In some examples, all or portions of the functionality described with respect to retrieval unit 52 may be implemented in hardware, or a combination of hardware, software, and/or firmware, where requisite hardware may be provided to execute instructions for software or firmware.

Retrieval unit 52 may compare the decoding and rendering capabilities of client device 40 to characteristics of representations 68 indicated by information of manifest file 66. Retrieval unit 52 may initially retrieve at least a portion of manifest file 66 to determine characteristics of representations 68. For example, retrieval unit 52 may request a portion of manifest file 66 that describes characteristics of one or more adaptation sets. Retrieval unit 52 may select a subset of representations 68 (e.g., an adaptation set) having characteristics that can be satisfied by the coding and rendering capabilities of client device 40. Retrieval unit 52 may then determine bitrates for representations in the adaptation set, determine a currently available amount of network bandwidth, and retrieve segments from one of the representations having a bitrate that can be satisfied by the network bandwidth.

In general, higher bitrate representations may yield higher quality video playback, while lower bitrate representations may provide sufficient quality video playback when available network bandwidth decreases. Accordingly, when available network bandwidth is relatively high, retrieval unit 52 may retrieve data from relatively high bitrate representations, whereas when available network bandwidth is low, retrieval unit 52 may retrieve data from relatively low bitrate representations. In this manner, client device 40 may stream multimedia data over network 74 while also adapting to changing network bandwidth availability of network 74.

Additionally or alternatively, retrieval unit 52 may be configured to receive data in accordance with a broadcast or multicast network protocol, such as eMBMS or IP multicast. In such examples, retrieval unit 52 may submit a request to join a multicast network group associated with particular media content. After joining the multicast group, retrieval unit 52 may receive data of the multicast group without further requests issued to server device 60 or content preparation device 20. Retrieval unit 52 may submit a request to leave the multicast group when data of the multicast group is no longer needed, e.g., to stop playback or to change channels to a different multicast group.

Network interface 54 may receive and provide data of segments of a selected representation to retrieval unit 52, which may in turn provide the segments to decapsulation unit 50. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

Video encoder 28, video decoder 48, audio encoder 26, audio decoder 46, encapsulation unit 30, retrieval unit 52, and decapsulation unit 50 each may be implemented as any of a variety of suitable processing circuitry, as applicable, such as one or more microprocessors, digital signal processors (DSPs), application specific integrated circuits (ASICs), field programmable gate arrays (FPGAs), discrete logic circuitry, software, hardware, firmware or any combinations thereof. Each of video encoder 28 and video decoder 48 may be included in one or more encoders or decoders, either of which may be integrated as part of a combined video encoder/decoder (CODEC). Likewise, each of audio encoder 26 and audio decoder 46 may be included in one or more encoders or decoders, either of which may be integrated as part of a combined CODEC. An apparatus including video encoder 28, video decoder 48, audio encoder 26, audio decoder 46, encapsulation unit 30, retrieval unit 52, and/or decapsulation unit 50 may comprise an integrated circuit, a microprocessor, and/or a wireless communication device, such as a cellular telephone.

Client device 40, server device 60, and/or content preparation device 20 may be configured to operate in accordance with the techniques of this disclosure. For purposes of example, this disclosure describes these techniques with respect to client device 40 and server device 60. However, it should be understood that content preparation device 20 may be configured to perform these techniques, instead of (or in addition to) server device 60.

Encapsulation unit 30 may form NAL units comprising a header that identifies a program to which the NAL unit belongs, as well as a payload, e.g., audio data, video data, or data that describes the transport or program stream to which the NAL unit corresponds. For example, in H.264/AVC, a NAL unit includes a 1-byte header and a payload of varying size. A NAL unit including video data in its payload may comprise various granularity levels of video data. For example, a NAL unit may comprise a block of video data, a plurality of blocks, a slice of video data, or an entire picture of video data. Encapsulation unit 30 may receive encoded video data from video encoder 28 in the form of PES packets of elementary streams. Encapsulation unit 30 may associate each elementary stream with a corresponding program.

Encapsulation unit 30 may also assemble access units from a plurality of NAL units. In general, an access unit may comprise one or more NAL units for representing a frame of video data, as well as audio data corresponding to the frame when such audio data is available. An access unit generally includes all NAL units for one output time instance, e.g., all audio and video data for one time instance. For example, if each view has a frame rate of 20 frames per second (fps), then each time instance may correspond to a time interval of 0.05 seconds. During this time interval, the specific frames for all views of the same access unit (the same time instance) may be rendered simultaneously. In one example, an access unit may comprise a coded picture in one time instance, which may be presented as a primary coded picture.

Accordingly, an access unit may comprise all audio and video frames of a common temporal instance, e.g., all views corresponding to time X. This disclosure also refers to an encoded picture of a particular view as a “view component.” That is, a view component may comprise an encoded picture (or frame) for a particular view at a particular time. Accordingly, an access unit may be defined as comprising all view components of a common temporal instance. The decoding order of access units need not necessarily be the same as the output or display order.

A media presentation may include a media presentation description (MPD), which may contain descriptions of different alternative representations (e.g., video services with different qualities) and the description may include, e.g., codec information, a profile value, and a level value. An MPD is one example of a manifest file, such as manifest file 66. Client device 40 may retrieve the MPD of a media presentation to determine how to access movie fragments of various presentations. Movie fragments may be located in movie fragment boxes (moof boxes) of video files.

Manifest file 66 (which may comprise, for example, an MPD) may advertise availability of segments of representations 68. That is, the MPD may include information indicating the wall-clock time at which a first segment of one of representations 68 becomes available, as well as information indicating the durations of segments within representations 68. In this manner, retrieval unit 52 of client device 40 may determine when each segment is available, based on the starting time as well as the durations of the segments preceding a particular segment.

After encapsulation unit 30 has assembled NAL units and/or access units into a video file based on received data, encapsulation unit 30 passes the video file to output interface 32 for output. In some examples, encapsulation unit 30 may store the video file locally or send the video file to a remote server via output interface 32, rather than sending the video file directly to client device 40. Output interface 32 may comprise, for example, a transmitter, a transceiver, a device for writing data to a computer-readable medium such as, for example, an optical drive, a magnetic media drive (e.g., floppy drive), a universal serial bus (USB) port, a network interface, or other output interface. Output interface 32 outputs the video file to a computer-readable medium, such as, for example, a transmission signal, a magnetic medium, an optical medium, a memory, a flash drive, or other computer-readable medium.

Network interface 54 may receive a NAL unit or access unit via network 74 and provide the NAL unit or access unit to decapsulation unit 50, via retrieval unit 52. Decapsulation unit 50 may decapsulate elements of a video file into constituent PES streams, depacketize the PES streams to retrieve encoded data, and send the encoded data to either audio decoder 46 or video decoder 48, depending on whether the encoded data is part of an audio or video stream, e.g., as indicated by PES packet headers of the stream. Audio decoder 46 decodes encoded audio data and sends the decoded audio data to audio output 42, while video decoder 48 decodes encoded video data and sends the decoded video data, which may include a plurality of views of a stream, to video output 44.

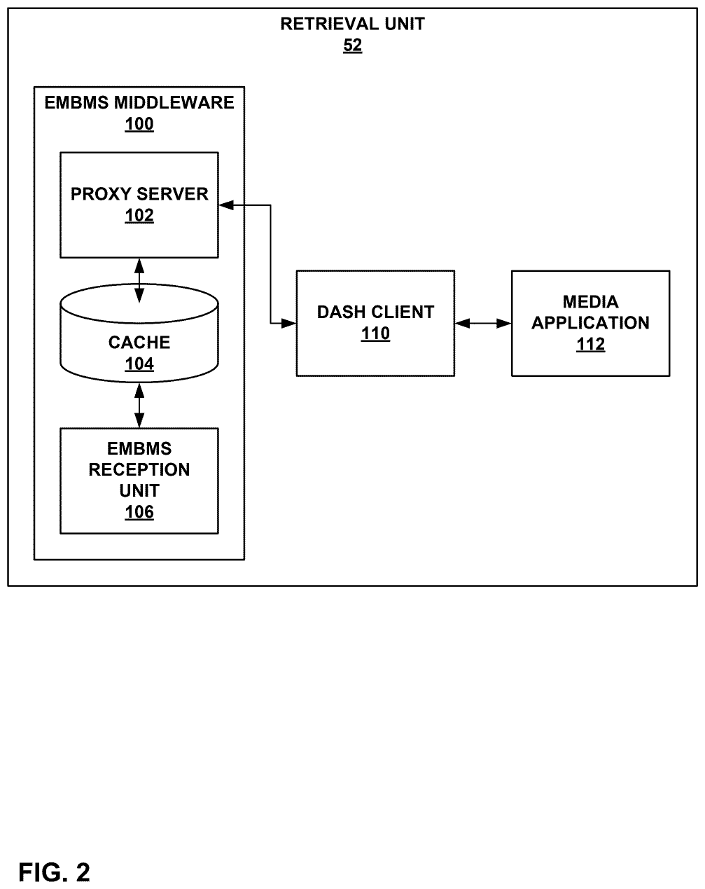

FIG. 2 is a block diagram illustrating an example set of components of retrieval unit 52 of FIG. 1 in greater detail. In this example, retrieval unit 52 includes eMBMS middleware unit 100, DASH client 110, and media application 112.

In this example, eMBMS middleware unit 100 further includes eMBMS reception unit 106, cache 104, and proxy server unit 102. In this example, eMBMS reception unit 106 is configured to receive data via eMBMS, e.g., according to File Delivery over Unidirectional Transport (FLUTE), described in T. Paila et al., “FLUTE-File Delivery over Unidirectional Transport,” Network Working Group, RFC 6726 November 2012, available at tools.ietf.org/html/rfc6726. That is, eMBMS reception unit 106 may receive files via broadcast from, e.g., server device 60, which may act as a broadcast/multicast service center (BM-SC).

As eMBMS middleware unit 100 receives data for files, eMBMS middleware unit may store the received data in cache 104. Cache 104 may comprise a computer-readable storage medium, such as flash memory, a hard disk, RAM, or any other suitable storage medium.

Proxy server unit 102 may act as a server for DASH client 110. For example, proxy server unit 102 may provide a MPD file or other manifest file to DASH client 110. Proxy server unit 102 may advertise availability times for segments in the MPD file, as well as hyperlinks from which the segments can be retrieved. These hyperlinks may include a localhost address prefix corresponding to client device 40 (e.g., 127.0.0.1 for IPV4). In this manner, DASH client 110 may request segments from proxy server unit 102 using HTTP GET or partial GET requests. For example, for a segment available from link http://127.0.0.1/rep1/seg3, DASH client 110 may construct an HTTP GET request that includes a request for http://127.0.0.1/rep1/seg3, and submit the request to proxy server unit 102. Proxy server unit 102 may retrieve requested data from cache 104 and provide the data to DASH client 110 in response to such requests.

The MPEG DASH standard (ISO/IEC 23009-1 Fifth Edition, August 2022) describes a service description in Annex K. The service description allows for configuration of a DASH client for playback and other operational purposes. The service description may use a formalized API description. The configuration of the API may be supported with typical API communication, e.g., feedback from the engine may be provided, as well as status reporting/notifications. In case no application is available, MPEG-DASH provides for sending configuration information in the MPD at the MPD and Period levels. This allows for static or semi-static updates of the service description.

The Service Description includes various parameters, such as service latency, playback rate, operating quality, operating bandwidth, content steering, and client-metadata reporting configuration.

DASH.js, per cdn.dashjs.org/latest/jsdoc/module-Settings.html, allows for the following settings:
AbandonRequestRuleParameters
AbrRulesParameters
AbrSettings
Audio VideoSettings
Buffer
CachingInfoSettings
Capabilities
CmcdSettings
CmsdAbrSettings
CmsdSettings
DebugSettings
ErrorSettings
Gaps
LiveCatchupSettings Playback Rate
LiveDelay
Metrics
PlayerSettings
Protection
RequestTypeSettings
Scheduling
StreamingSettings
Text
TimeShiftBuffer
UtcSynchronizationSettings

A subset of the above settings can be configured through the service description.

DASH.js also allows for providing notifications from the media player to the media streaming application, as discussed at cdn.dashjs.org/latest/jsdoc/MediaPlayerEvents.html.

This disclosure recognizes that the service description in MPEG DASH only supports a subset of the configurations of dash.js. While several of these elements may not be relevant for configuration, some are. This disclosure recognizes that certain DASH.js settings should be remotely configurable. In some instances, changes could be performed dynamically in DASH.js. For example, common media client data (CMCD) reporting could be turned on and off, the latency for playback may be changed, and operational settings may be updated. The MPD based configuration is generally static or can only be changed at Period boundaries. The latter is a content property, but not operational. This disclosure recognizes that it would be beneficial to perform configuration updates in a manner aligned with media times, or to trigger such configuration updates quickly when an operational change is needed.

Moreover, generally, the service configuration can be sent, but if the configuration is not successful or if other type of status or notifications are generated in the DASH client, this information cannot be provided as part of the MPD and over the network, according to conventional techniques. Configurations are supported by feedback, notifications, and events. However, in the absences of a media streaming application, such events are not fired and not made available to the sender. For example, CMCD does not allow to send DASH.js events and notifications.

According to the techniques of this disclosure, server device 60 may send and client device 40 may receive an extended service description with additional parameters. The extended service description may include any or all of 1) a recommended abandon request rule (ABR) strategy, which allows the service provider to configure an ABR algorithm (e.g., per “AbrSettings” below); 2) a buffer configuration, which allows the service provider to configure buffer handling (e.g., per “Buffer” below); 3) Gaps, which allows for support of consistent gap handling (per “Gaps” below); and/or 4) Scheduling (per “Scheduling” below).

### 1) AbrSettings

| Name | Type | Attributes | Default | Description |
|---|---|---|---|---|
| movingAverageMethod | string | <optional> | “sliding Window” | Sets the moving average |
| | | | | method used for |
| | | | | smoothing throughput |
| | | | | estimates. |
| | | | | Valid methods are |
| | | | | “sliding Window” and |
| | | | | “ewma”. |
| | | | | The call has no effect if an |
| | | | | invalid method is passed. |
| | | | | The sliding window |
| | | | | moving average method |
| | | | | computes the average |
| | | | | throughput using the last |
| | | | | four segments |
| | | | | downloaded. |
| | | | | If the stream is live (as |
| | | | | opposed to VOD), then |
| | | | | only the last three |
| | | | | segments are used. |
| | | | | If wide variations in |
| | | | | throughput are detected, |
| | | | | the number of segments |
| | | | | can be dynamically |
| | | | | increased to avoid |
| | | | | oscillations. |
| | | | | The exponentially |
| | | | | weighted moving average |
| | | | | (EWMA) method |
| | | | | computes the average |
| | | | | using exponential |
| | | | | smoothing. |
| | | | | Two separate estimates |
| | | | | are maintained, a fast one |
| | | | | with a three-second half |
| | | | | life and a slow one with |
| | | | | an eight-second half life. |
| | | | | The throughput estimate |
| | | | | at any time is the |
| | | | | minimum of the fast and |
| | | | | slow estimates. |
| | | | | This allows a fast reaction |
| | | | | to a bandwidth drop and |
| | | | | prevents oscillations on |
| | | | | bandwidth spikes. |

### 2) Buffer Configuration

| Name | Type | Attributes | Default | Description |
|---|---|---|---|---|
| enableSeekDecorrelationFix | boolean | <optional> | false | Enables a workaround for |
| | | | | playback start on some |
| | | | | devices, e.g. WebOS 4.9. |
| | | | | It is necessary because some |
| | | | | browsers do not support |
| | | | | setting currentTime on video |
| | | | | element to a value that is |
| | | | | outside of current buffer. |
| | | | | If you experience unexpected |
| | | | | seeking triggered by |
| | | | | BufferController, you can try |
| | | | | setting this value to false. |
| fastSwitchEnabled | boolean | <optional> | true | When enabled, after an ABR |
| | | | | up-switch in quality, instead |
| | | | | of requesting and appending |
| | | | | the next fragment at the end |
| | | | | of the current buffer range it |
| | | | | is requested and appended |
| | | | | closer to the current time. |
| | | | | When enabled, The |
| | | | | maximum time to render a |
| | | | | higher quality is current |
| | | | | time + (1.5 * fragment |
| | | | | duration). |
| | | | | Note, When ABR down- |
| | | | | switch is detected, we |
| | | | | appended the lower quality at |
| | | | | the end of the buffer range to |
| | | | | preserve the |
| | | | | higher quality media for as |
| | | | | long as possible. |
| | | | | If enabled, it should be noted |
| | | | | there are a few cases when |
| | | | | the client will not replace |
| | | | | inside buffer range but rather |
| | | | | just append at the end. |
| | | | | 1. When the buffer level |
| | | | | is less than one |
| | | | | fragment duration. |
| | | | | 2. The client is in an |
| | | | | Abandonment State |
| | | | | due to recent fragment |
| | | | | abandonment event. |
| | | | | Known issues: |
| | | | | 1. In IE11 with auto |
| | | | | switching off, if a user |
| | | | | switches to a quality |
| | | | | they can not |
| | | | | download in time the |
| | | | | fragment may be |
| | | | | appended in the same |
| | | | | range as the playhead |
| | | | | or even in the past, in |
| | | | | IE11 it may cause a |
| | | | | stutter or stall in |
| | | | | playback |

### 3) Gaps

| Name | Type | Attributes | Default | Description |
|---|---|---|---|---|
| jumpGaps | boolean | <optional> | true | Sets whether player should jump small |
| | | | | gaps (discontinuities) in the buffer. |
| jumpLargeGaps | boolean | <optional> | true | Sets whether player should jump large |
| | | | | gaps (discontinuities) in the buffer. |
| smallGapLimit | number | <optional> | 1.5 | Time in seconds for a gap to be |
| | | | | considered small. |
| threshold | number | <optional> | 0.3 | Threshold at which the gap handling is |
| | | | | executed. If currentRangeEnd − |
| | | | | currentTime < threshold the gap jump will |
| | | | | be triggered. |
| | | | | For live stream the jump might be delayed |
| | | | | to keep a consistent live edge. |
| | | | | Note that the amount of buffer at which |
| | | | | platforms automatically stall might differ. |
| enableSeekFix | boolean | <optional> | true | Enables the adjustment of the seek target |
| | | | | once no valid segment request could be |
| | | | | generated for a specific seek time. This |
| | | | | can happen if the user seeks to a position |
| | | | | for which there is a gap in the timeline. |
| enableStallFix | boolean | <optional> | false | If playback stalled in a buffered range this |
| | | | | fix will perform a seek by the value |
| | | | | defined in stallSeek to trigger playback |
| | | | | again. |
| stallSeek | number | <optional> | 0.1 | Value to be used in case enableStallFix is |
| | | | | set to true |

### 4) Scheduling

| Name | Type | Attributes | Default | Description |
|---|---|---|---|---|
| defaultTimeout | number | <optional> | 500 | Default timeout between two |
| | | | | consecutive segment scheduling |
| | | | | attempts |
| lowLatencyTimeout | number | <optional> | 0 | Default timeout between two |
| | | | | consecutive low-latency segment |
| | | | | scheduling attempts |
| scheduleWhilePaused | boolean | <optional> | true | Set to true if you would like dash.js |
| | | | | to keep downloading fragments in |
| | | | | the background when the video |
| | | | | element is paused. |

Per the techniques of this disclosure, server device 60 may signal configuration updates using service descriptions using Events. That is, server device 60 may send a service description event as part of manifest file 66. The event message may include a media time at which the configuration update needs to be provided; configuration information to be applied; and/or call back information that allows client device 40 to send a response when applying the configuration information.

Section K.6 below may be added to MPEG DASH to support these techniques:

### K.6 Service Description Event

### K.6.1 General

This clause provides the ability to initiate the service description information using a DASH MPD Event. Two options are defined.

In one case, Service Descriptions are provided with an identifier in the MPD and are scoped to be activated by Events, the Scope@schemeIdURI is set to urn: mpeg: dash: event: service-description:2024. Note that Service Descriptions with the scope above are not to be selected by the DASH client unless they are activated by an event.

In the second case, the Service Description information is directly included in the Event message.

The semantics are provided in clause K.6.2.

A client processing model is provided in clause K.6.3.

### K.6.2 Semantics

TABLE 47
Semantics of Service Description Event

| Key | Description |
|---|---|
| schemeIdURI | Set to urn:mpeg:dash:event:service-description:2024 |
| presentation_time | Provides the media presentation time when the service |
| | description is activated. |
| value | Not applicable |
| duration | Provides the duration after presentation time after which the |
| | Service Description may still be activated. |
| message | Provides the identifier of the Service Description to be |
| | activated as defined in the Service description element. |
| | If present, then the DASH MPD element shall not include a |
| | ServiceDescription element. |
| | If not present, then the DASH MPD element shall include a |
| | ServiceDescription element that includes the information for |
| | activation. |

The above values are mapped to presentation time, duration and the message of the event and may be carried in the MPD or inband.

### K.6.3 Client Processing Model

When processing Service Description Event, the following is applied:
If an Event is received with a new Event@id, then the client acts as follows:
   The processor uses the start time of the event to determine when the service description is activated.
   All information in the Event is used according to the semantic in clause K.6.2.
else the Event is ignored.

### K.6.4 Example

In the following MPD example, two Service Descriptions are defined that are activated by Events with different target latencies and CMCD reporting. In addition, an Event stream is defined with three Events. Two of the events refer to existing Service Descriptions, one provides a new service description as part of the Event.

```
  <MPD xmlns:xsi=“http://www.w3.org/2001/XMLSchema-instance”
    xmlns=“urn:mpeg:dash:schema:mpd:2011”
    xsi:schemaLocation=“urn:mpeg:dash:schema:mpd:2011 DASH-MPD.xsd”
    type=“dynamic”
    minimumUpdatePeriod=“PT30S”
    timeShiftBufferDepth=“PT30M”
    availabilityStartTime=“2022-02-25T12:30:00”
    minBufferTime=“PT4S”
    profiles=“urn:mpeg:dash:profile:isoff-live:2011”>
      <ServiceDescription id=“1250”>
        <Scope schemeIdUri=“urn:mpeg:dash:event:service-
description:2024”/>
        <Latency min=“750” max=“4200” target=“1250”
referenceId=“7”/>
        <PlaybackRate min=“0.96” max=“1.04”/>
        <ClientDataReporting scheme=“urn:mpeg:dash:cta-
5004:2023” serviceLocations=“beta” adaptationSets=“video”>
          <CMCDParameters mode=“header”
includeInRequests=“*” keys=“br,bl,cid,dl,mtp,nor,ot,sf,v”/>
        </ClientDataReporting>
      </ServiceDescription>
      <ServiceDescription id=“2500”>
        <Scope schemeIdUri=“urn:mpeg:dash:event:service-
description:2024”/>
        <Latency min=“750” max=“4200” target=“2500”
referenceId=“7”/>
        <PlaybackRate min=“0.96” max=“1.04”/>
        <ClientDataReporting scheme=“urn:mpeg:dash:cta-
5004:2023” serviceLocations=“beta” adaptationSets=“video”>
          <CMCDParameters mode=“header”
includeInRequests=“*” keys=“br,bl,cid,dl,mtp,nor”/>
        </ClientDataReporting>
      </ServiceDescription>
      <BaseURL
serviceLocation=“alpha”>https://cdn1.example.com/</BaseURL>
      <BaseURL
serviceLocation=“beta”>https://cdn2.example.com/</BaseURL>
      <Period id=“1”>
        <EventStream schemeIdUri=“urn:mpeg:dash:event:service-
description:2024” timescale=“1000”>
          <Event presentationTime=“0” duration=“60000” id=“0”
messageData=“1250”/>
          <Event presentationTime=“60000” duration=“60000”
id=“1” messageData=“2500”/>
          <Event presentationTime=“120000” duration=“60000”
id=“2”>
            <ServiceDescription id=“2000”>
              <Latency min=“750” max=“4200”
target=“2000” referenceId=“7”/>
              <PlaybackRate min=“0.96”
max=“1.04”/>
              <ClientDataReporting
scheme=“urn:mpeg:dash:cta-5004:2023” serviceLocations=“beta”
adaptationSets=“video”>
                <CMCDParameters
mode=“header” includeInRequests=“*” keys=“br,bl,cid,dl,mtp”/>
              </ClientDataReporting>
            </ServiceDescription>
          </Event>
        </EventStream>
        <AdaptationSet id=“video” mimeType=“video/mp4”
codecs=“avc1.4D401F” frameRate=“30000/1001” segmentAlignment=“true”
startWithSAP=“1”>
          <BaseURL>video/</BaseURL>
        ...
        </AdaptationSet>
      </Period>
  </MPD>
```

Notifications of the DASH client may be of relevance not only for the application, but also for the network. However, not all notifications may be of the same relevance. Some of the events and notifications may also be included in some reporting schemes. The events highlighted in bold and marked “can be networked” below may be suitable for being networked:
1. AST_IN_FUTURE
2. BASE_URLS_UPDATED
3. BUFFER_EMPTY—can be networked
4. BUFFER_LEVEL_STATE_CHANGED
5. BUFFER_LEVEL_UPDATED
6. BUFFER_LOADED
7. CAN_PLAY
8. CAN_PLAY_THROUGH
9. CAPTION_CONTAINER_RESIZE
10. CAPTION_RENDERED
11. CONFORMANCE_VIOLATION—can be networked
12. CONTENT_STEERING_REQUEST_COMPLETED
13. CUE_ENTER
14. CUE_ENTER
15. DVB_FONT_DOWNLOAD_ADDED
16. DVB_FONT_DOWNLOAD_COMPLETE
17. DVB_FONT_DOWNLOAD_FAILED
18. DYNAMIC_TO_STATIC—can be networked
19. ERROR
20. EVENT_MODE_ON_RECEIVE
21. EVENT_MODE_ON_START
22. FRAGMENT_LOADING_ABANDONED
23. FRAGMENT_LOADING_COMPLETED
24. FRAGMENT_LOADING_PROGRESS
25. FRAGMENT_LOADING_STARTED
26. INBAND_PRFT—can be networked
27. LOG
28. MANIFEST_LOADED
29. MANIFEST_LOADING_FINISHED
30. MANIFEST_LOADING_STARTED
31. MANIFEST_VALIDITY_CHANGED
32. METRIC_ADDED
33. METRIC_CHANGED
34. METRIC_UPDATED
35. METRICS_CHANGED
36. PERIOD_SWITCH_COMPLETED
37. PERIOD_SWITCH_STARTED
38. PLAYBACK_ENDED—can be networked
39. PLAYBACK_ERROR
40. PLAYBACK_LOADED_DATA
41. PLAYBACK_METADATA_LOADED
42. PLAYBACK_NOT_ALLOWED
43. PLAYBACK_PAUSED
44. PLAYBACK_PLAYING
45. PLAYBACK_PROGRESS—can be networked
46. PLAYBACK_RATE_CHANGED—can be networked
47. PLAYBACK_SEEKED
48. PLAYBACK SEEKING
49. PLAYBACK_STALLED—can be networked
50. PLAYBACK_STARTED
51. PLAYBACK_TIME_UPDATED
52. PLAYBACK_VOLUME_CHANGED
53. PLAYBACK_WAITING
54. QUALITY_CHANGE_RENDERED
55. QUALITY_CHANGE_REQUESTED
56. REPRESENTATION_SWITCH—can be networked
57. STREAM_ACTIVATED
58. STREAM_DEACTIVATED
59. STREAM_INITIALIZED
60. STREAM_INITIALIZING
61. STREAM_TEARDOWN_COMPLETE
62. STREAM_UPDATED
63. TEXT_TRACK_ADDED
64. TEXT_TRACKS_ADDED
65. THROUGHPUT_MEASUREMENT_STORED
66. TRACK_CHANGE_RENDERED
67. TTML_PARSED
68. TTML_TO_PARSE

Client device 40 may send such notifications in various ways. In one example, client device 40 may send the notifications as a part of CMCD reporting. In addition, relevant notification events that are not yet included in CMCD may be added. Additionally or alternatively, client device 40 may send these notifications as part of a callback event that is initiated through a service description extension. A callback may be triggered whenever an event is happening. This can be combined with CMCD, and the reporting of specific CMCD metrics may be done as part of a callback.

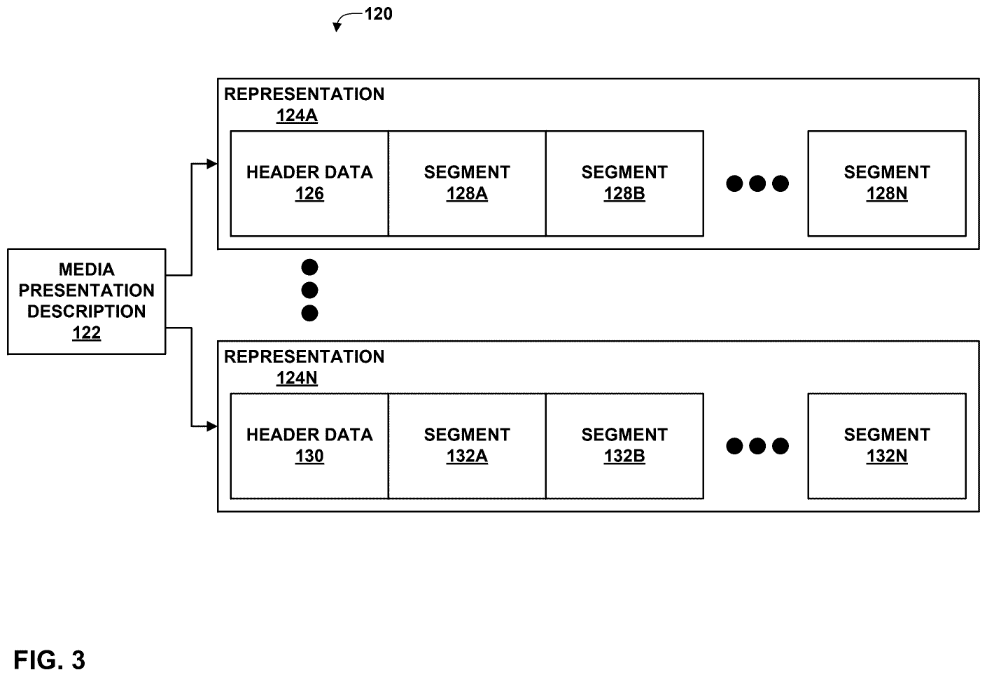

FIG. 3 is a conceptual diagram illustrating elements of example multimedia content 120. Multimedia content 120 may correspond to multimedia content 64 (FIG. 1), or another multimedia content stored in storage medium 62. In the example of FIG. 3, multimedia content 120 includes media presentation description (MPD) 122 and a plurality of representations 124A-124N (representations 124). Representation 124A includes optional header data 126 and segments 128A-128N (segments 128), while representation 124N includes optional header data 130 and segments 132A-132N (segments 132). The letter N is used to designate the last movie fragment in each of representations 124 as a matter of convenience. In some examples, there may be different numbers of movie fragments between representations 124.

MPD 122 may comprise a data structure separate from representations 124. MPD 122 may correspond to manifest file 66 of FIG. 1. Likewise, representations 124 may correspond to representations 68 of FIG. 1. In general, MPD 122 may include data that generally describes characteristics of representations 124, such as coding and rendering characteristics, adaptation sets, a profile to which MPD 122 corresponds, text type information, camera angle information, rating information, trick mode information (e.g., information indicative of representations that include temporal sub-sequences), and/or information for retrieving remote periods (e.g., for targeted advertisement insertion into media content during playback).

Header data 126, when present, may describe characteristics of segments 128, e.g., temporal locations of random access points (RAPs, also referred to as stream access points (SAPs)), which of segments 128 includes random access points, byte offsets to random access points within segments 128, uniform resource locators (URLs) of segments 128, or other aspects of segments 128. Header data 130, when present, may describe similar characteristics for segments 132. Additionally or alternatively, such characteristics may be fully included within MPD 122.

Segments 128, 132 include one or more coded video samples, each of which may include frames or slices of video data. Each of the coded video samples of segments 128 may have similar characteristics, e.g., height, width, and bandwidth requirements. Such characteristics may be described by data of MPD 122, though such data is not illustrated in the example of FIG. 3. MPD 122 may include characteristics as described by the 3GPP Specification, with the addition of any or all of the signaled information described in this disclosure.

Each of segments 128, 132 may be associated with a unique uniform resource locator (URL). Thus, each of segments 128, 132 may be independently retrievable using a streaming network protocol, such as DASH. In this manner, a destination device, such as client device 40, may use an HTTP GET request to retrieve segments 128 or 132. In some examples, client device 40 may use HTTP partial GET requests to retrieve specific byte ranges of segments 128 or 132.

In accordance with the techniques of this disclosure, MPD 122 may include a Period element including an EventStream element signaling that a DASH event message including configuration data to be applied at a particular time may be sent.

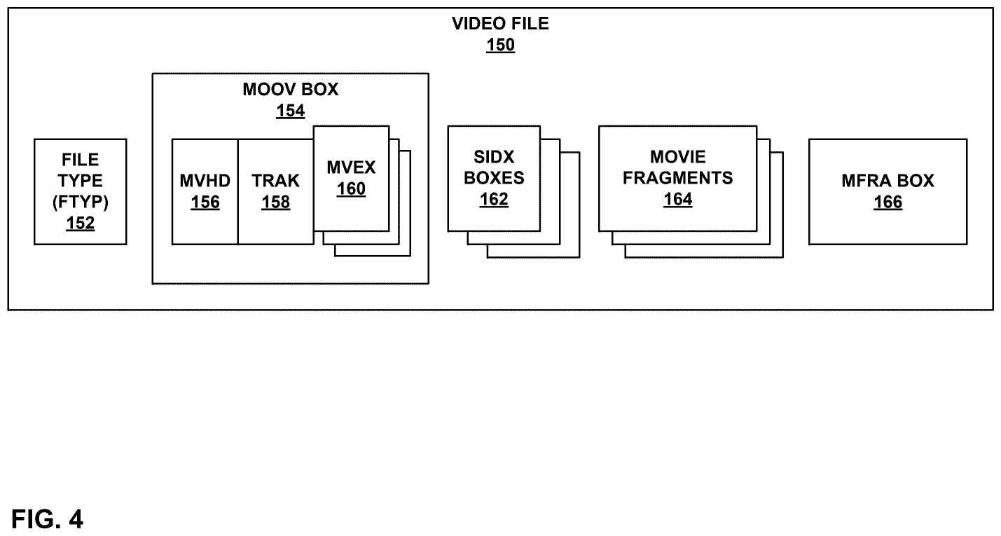

FIG. 4 is a block diagram illustrating elements of an example video file 150, which may correspond to a segment of a representation, such as one of segments 128, 132 of FIG. 3. Each of segments 128, 132 may include data that conforms substantially to the arrangement of data illustrated in the example of FIG. 4. Video file 150 may be said to encapsulate a segment. As described above, video files in accordance with the ISO base media file format and extensions thereof store data in a series of objects, referred to as “boxes.” In the example of FIG. 4, video file 150 includes file type (FTYP) box 152, movie (MOOV) box 154, segment index (sidx) boxes 162, movie fragment (MOOF) boxes 164, and movie fragment random access (MFRA) box 166. Although FIG. 4 represents an example of a video file, it should be understood that other media files may include other types of media data (e.g., audio data, timed text data, or the like) that is structured similarly to the data of video file 150, in accordance with the ISO base media file format and its extensions.

File type (FTYP) box 152 generally describes a file type for video file 150. File type box 152 may include data that identifies a specification that describes a best use for video file 150. File type box 152 may alternatively be placed before MOOV box 154, movie fragment boxes 164, and/or MFRA box 166.

In some examples, a Segment, such as video file 150, may include an MPD update box (not shown) before FTYP box 152. The MPD update box may include information indicating that an MPD corresponding to a representation including video file 150 is to be updated, along with information for updating the MPD. For example, the MPD update box may provide a URI or URL for a resource to be used to update the MPD. As another example, the MPD update box may include data for updating the MPD. In some examples, the MPD update box may immediately follow a segment type (STYP) box (not shown) of video file 150, where the STYP box may define a segment type for video file 150.

MOOV box 154, in the example of FIG. 4, includes movie header (MVHD) box 156, track (TRAK) box 158, and one or more movie extends (MVEX) boxes 160. In general, MVHD box 156 may describe general characteristics of video file 150. For example, MVHD box 156 may include data that describes when video file 150 was originally created, when video file 150 was last modified, a timescale for video file 150, a duration of playback for video file 150, or other data that generally describes video file 150.

TRAK box 158 may include data for a track of video file 150. TRAK box 158 may include a track header (TKHD) box that describes characteristics of the track corresponding to TRAK box 158. In some examples, TRAK box 158 may include coded video pictures, while in other examples, the coded video pictures of the track may be included in movie fragments 164, which may be referenced by data of TRAK box 158 and/or sidx boxes 162.

In some examples, video file 150 may include more than one track. Accordingly, MOOV box 154 may include a number of TRAK boxes equal to the number of tracks in video file 150. TRAK box 158 may describe characteristics of a corresponding track of video file 150. For example, TRAK box 158 may describe temporal and/or spatial information for the corresponding track. A TRAK box similar to TRAK box 158 of MOOV box 154 may describe characteristics of a parameter set track, when encapsulation unit 30 (FIG. 3) includes a parameter set track in a video file, such as video file 150. Encapsulation unit 30 may signal the presence of sequence level SEI messages in the parameter set track within the TRAK box describing the parameter set track.

MVEX boxes 160 may describe characteristics of corresponding movie fragments 164, e.g., to signal that video file 150 includes movie fragments 164, in addition to video data included within MOOV box 154, if any. In the context of streaming video data, coded video pictures may be included in movie fragments 164 rather than in MOOV box 154. Accordingly, all coded video samples may be included in movie fragments 164, rather than in MOOV box 154.

MOOV box 154 may include a number of MVEX boxes 160 equal to the number of movie fragments 164 in video file 150. Each of MVEX boxes 160 may describe characteristics of a corresponding one of movie fragments 164. For example, each MVEX box may include a movie extends header box (MEHD) box that describes a temporal duration for the corresponding one of movie fragments 164.

As noted above, encapsulation unit 30 may store a sequence data set in a video sample that does not include actual coded video data. A video sample may generally correspond to an access unit, which is a representation of a coded picture at a specific time instance. In the context of AVC, the coded picture includes one or more VCL NAL units, which contain the information to construct all the pixels of the access unit and other associated non-VCL NAL units, such as SEI messages. Accordingly, encapsulation unit 30 may include a sequence data set, which may include sequence level SEI messages, in one of movie fragments 164. Encapsulation unit 30 may further signal the presence of a sequence data set and/or sequence level SEI messages as being present in one of movie fragments 164 within the one of MVEX boxes 160 corresponding to the one of movie fragments 164.

SIDX boxes 162 are optional elements of video file 150. That is, video files conforming to the 3GPP file format, or other such file formats, do not necessarily include SIDX boxes 162. In accordance with the example of the 3GPP file format, a SIDX box may be used to identify a sub-segment of a segment (e.g., a segment contained within video file 150). The 3GPP file format defines a sub-segment as “a self-contained set of one or more consecutive movie fragment boxes with corresponding Media Data box(es) and a Media Data Box containing data referenced by a Movie Fragment Box must follow that Movie Fragment box and precede the next Movie Fragment box containing information about the same track.” The 3GPP file format also indicates that a SIDX box “contains a sequence of references to subsegments of the (sub) segment documented by the box. The referenced subsegments are contiguous in presentation time. Similarly, the bytes referred to by a Segment Index box are always contiguous within the segment. The referenced size gives the count of the number of bytes in the material referenced.”

SIDX boxes 162 generally provide information representative of one or more sub-segments of a segment included in video file 150. For instance, such information may include playback times at which sub-segments begin and/or end, byte offsets for the sub-segments, whether the sub-segments include (e.g., start with) a stream access point (SAP), a type for the SAP (e.g., whether the SAP is an instantaneous decoder refresh (IDR) picture, a clean random access (CRA) picture, a broken link access (BLA) picture, or the like), a position of the SAP (in terms of playback time and/or byte offset) in the sub-segment, and the like.

Movie fragments 164 may include one or more coded video pictures. In some examples, movie fragments 164 may include one or more groups of pictures (GOPs), each of which may include a number of coded video pictures, e.g., frames or pictures. In addition, as described above, movie fragments 164 may include sequence data sets in some examples. Each of movie fragments 164 may include a movie fragment header box (MFHD, not shown in FIG. 4). The MFHD box may describe characteristics of the corresponding movie fragment, such as a sequence number for the movie fragment. Movie fragments 164 may be included in order of sequence number in video file 150.

MFRA box 166 may describe random access points within movie fragments 164 of video file 150. This may assist with performing trick modes, such as performing seeks to particular temporal locations (i.e., playback times) within a segment encapsulated by video file 150. MFRA box 166 is generally optional and need not be included in video files, in some examples. Likewise, a client device, such as client device 40, does not necessarily need to reference MFRA box 166 to correctly decode and display video data of video file 150. MFRA box 166 may include a number of track fragment random access (TFRA) boxes (not shown) equal to the number of tracks of video file 150, or in some examples, equal to the number of media tracks (e.g., non-hint tracks) of video file 150.

In some examples, movie fragments 164 may include one or more stream access points (SAPs), such as IDR pictures. Likewise, MFRA box 166 may provide indications of locations within video file 150 of the SAPs. Accordingly, a temporal sub-sequence of video file 150 may be formed from SAPs of video file 150. The temporal sub-sequence may also include other pictures, such as P-frames and/or B-frames that depend from SAPs. Frames and/or slices of the temporal sub-sequence may be arranged within the segments such that frames/slices of the temporal sub-sequence that depend on other frames/slices of the sub-sequence can be properly decoded. For example, in the hierarchical arrangement of data, data used for prediction for other data may also be included in the temporal sub-sequence.

FIG. 5 is a block diagram illustrating an example media streaming application 200 per techniques of this disclosure. Media streaming application 200 may correspond to retrieval unit 52 of FIG. 1 or DASH client 110 of FIG. 2. In this example, media streaming application 200 includes selection unit 202, DASH access unit 204, event processing unit 206, and media engine 208.

Per the techniques of this disclosure, DASH access unit 204 may receive data 210, which may include any or all of a manifest file (e.g., an MPD) of a media presentation, segment data (including media data of the media presentation), and/or a service description including configuration data to be applied to, e.g., media engine 208 or other components of media streaming application 200. DASH access unit 204 may receive an event message that activates the service description. The service description may be included in the manifest file or in an event message. For example, the service description may be included in a DASH event, which may have been signaled in an MPD received by DASH access unit 204 and processed by event processing unit 206. Event processing unit 206 may process configuration data of the DASH event at a time indicated for the DASH event.

DASH access unit 204 may provide MPD selection metadata 212 to selection unit 202, which sends data representing selected adaptation sets back to DASH access unit 204. Selection unit 202 may, for example, present output data to a user to indicate available adaptation sets, and the user may select one or more adaptation sets based on the presented data. For example, the user may select adaptation sets for various video data (e.g., 2D, 3D, particular resolutions, or the like), audio data (e.g., various languages), timed text data (e.g., subtitles in various languages), or the like.

DASH access unit 204 may use the data representing selected adaptation sets 214 to retrieve media data of the selected adaptation sets. DASH access unit 204 may also receive a service description, e.g., in a manifest file or in an Event message. When an Event message is received, DASH access unit 204 provides data from the Event message and timing information 216 to event processing unit 206. Event processing unit 206 may compare an identifier from the event message to an identifier for a service description and activate the service description having an identifier that matches the identifier in the event message.

Using configuration data from the service description, media streaming application 200 may consume and present media data according to the configuration data of the service description. The service description may, for example, include any or all of a service latency for the media presentation, a playback rate for the media presentation, an operating quality for the media presentation, an operating bandwidth for the media presentation, content steering for the media presentation, and/or metadata reporting configuration for the media presentation.

In this manner, DASH access unit 204 may receive media data 218 from DASH access unit 204. Media engine 208 may present media data 222 at a higher or lower playback rate per the service description, e.g., to satisfy a service latency within maximum and/or minimum playback rates as indicated by the service description. Media engine 208 may receive playback control data 220 to control playback of media data 222.

In this manner, a device executing media streaming application 200, such as client device 40 of FIG. 1, represents an example of a device for retrieving media data, including: a memory configured to store media data of a media presentation; and a processing system comprising one or more processors implemented in circuitry and configured to: receive an event message of the media presentation, the event message activating a service description for the media presentation, the service description including data representing how the media presentation is to be consumed, including one or more of a service latency for the media presentation, a playback rate for the media presentation, an operating quality for the media presentation, an operating bandwidth for the media presentation, content steering for the media presentation, or a metadata reporting configuration for the media presentation; receive the media data of the media presentation; and in response to receiving the event message of the media presentation activating the service description, present the media data according to the service description.

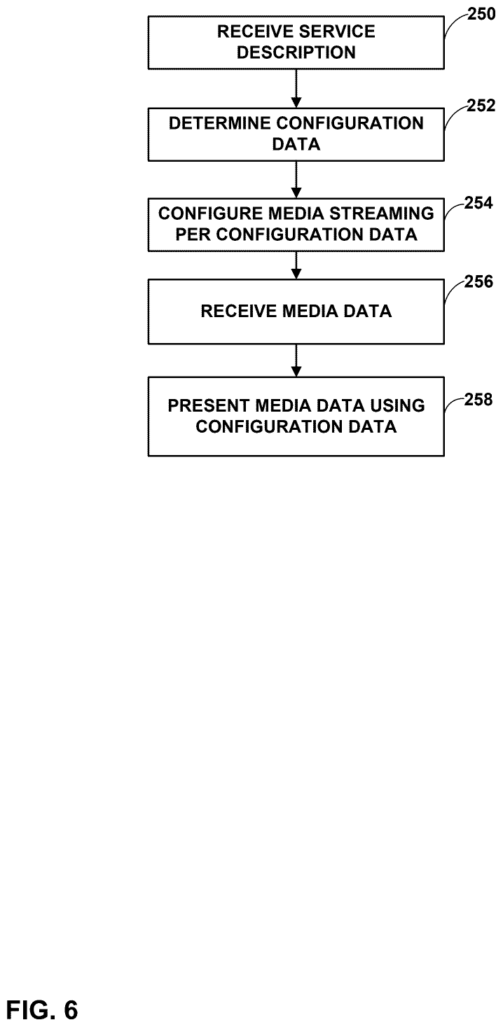

FIG. 6 is a flowchart illustrating an example method of using a service description for media presentation according to techniques of this disclosure. The method of FIG. 6 is explained with respect to client device 40 of FIG. 1, although other devices may be configured to perform this or a similar method.

In this example, client device 40 initially receives a service description (250). The service description includes configuration data including, for example, one or more of data representing an abandon request rule (ABR) strategy, a buffer configuration, gap handling, or scheduling. Thus, client device 40 may determine the configuration data of the service description (252). Client device 40 may then configure media streaming according to the configuration data of the service description (254). For example, client device 40 may configure a streaming application according to the ABR strategy, buffer configuration, gap handling, and/or scheduling configuration data of the service description. Client device 40 may then receive media data of a corresponding media presentation (256) and present the media data using the configuration data (258).

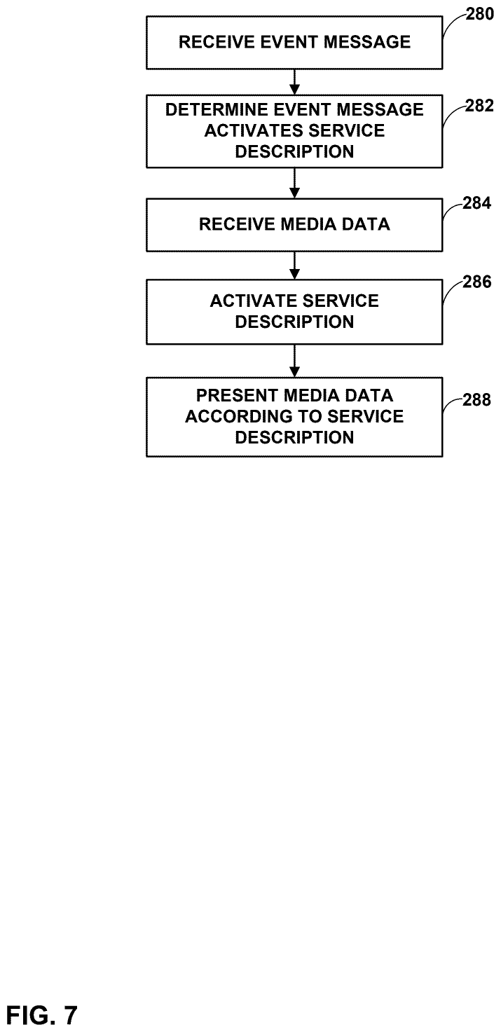

FIG. 7 is a flowchart illustrating an example method of receiving and using a service description according to techniques of this disclosure. The method of FIG. 7 is explained with respect to client device 40 of FIG. 1, although other devices may be configured to perform this or a similar method.

In this example, client device 40 receives an event message (280) during a streaming session for a media presentation. The event message may include an Event@id element and data indicating a start time at which to activate a service description. Client device 40 may receive a manifest file for the media presentation including the service description and an identifier for the service description, in which case the event message may include a corresponding identifier indicating that the service description is to be activated at the start time. Alternatively, the event message itself may include data defining the service description. Generally, client device 40 may determine that the event message activates the service description (282). The service description may include data indicating how the media presentation is to be consumed, e.g., a service latency for the media presentation, a playback rate for the media presentation, an operating quality for the media presentation, an operating bandwidth for the media presentation, content steering for the media presentation, and/or a metadata reporting configuration for the media presentation.

Thus, client device 40 may receive media data (284) of the media presentation. Client device 40 may also activate the service description (286). Accordingly, client device 40 may present the media data according to the service description (288). For example, client device 40 may increase or decrease a playback rate of the media data to satisfy a service latency specified in the service description. Additionally or alternatively, client device 40 may report data back to a server device or to a reporting server according to the service description.

In this manner, the method of FIG. 7 represents an example of a method of retrieving media data, including: receiving an event message of a media presentation, the event message including data representing a media presentation time at which a service description for the media presentation is to be activated; receiving media data of the media presentation; and in response to receiving the event message of the media presentation including the data representing the media presentation time at which the service description is to be activated, activating the service description at the media presentation time and presenting the media data according to the service description.

Various examples of the techniques of this disclosure are summarized in the following clauses:

Clause 1: A method of retrieving media data, the method comprising: receiving a service description including configuration information including one or more of data representing an abandon request rule (ABR) strategy, a buffer configuration, gap handling, or scheduling; configuring a media streaming application for playback and operation according to the configuration information of the service description; and using the configured media streaming application to retrieve media data.

Clause 2: The method of clause 1, wherein receiving the service description comprises receiving the service description according to an event message indicated by a manifest file for the media data.

Clause 3: The method of clause 2, wherein the event message is included in an Event element of an EventStream element at a Period level of the manifest file.

Clause 4: The method of any of clauses 2 and 3, wherein the manifest file comprises a Dynamic Adaptive Streaming over HTTP (DASH) media presentation description (MPD).

Clause 5: The method of any of clauses 2-4, wherein the event message includes a media time at which a configuration update indicated by the service description is to be provided.

Clause 6: The method of any of clauses 2-5, wherein the event message includes configuration information that is to be applied to the media streaming application.

Clause 7: The method of any of clauses 2-6, wherein the event message includes callback information for sending a response from the media streaming application after applying the configuration information.

Clause 8: The method of any of clauses 2-7, wherein the event message includes one or more of a schemeIdURI element, a presentation_time element, a value element, a duration element, or a message element.

Clause 9: The method of any of clauses 2-8, further comprising, in response to receiving the event message: determining that the event message includes a new Event@id element; determining a start time at which to apply the configuration information from the event message; and configuring the media streaming application at the determined start time.

Clause 10: The method of any of clauses 1-9, further comprising sending one or more notifications to one or more network devices other than a server device from which the media data is retrieved.

Clause 11: The method of clause 10, wherein the one or more notifications include one or more of a buffer empty notification, a conformance violation notification, a dynamic to static notification, an inband producer reference time (prft) notification, a playback ended notification, a playback progress notification, a playback rate changed notification, a playback stalled notification, or a representation switch notification.

Clause 12: The method of any of clauses 10 and 11, wherein sending the one or more notifications comprises sending the one or more notifications as part of common media client data (CMCD) reporting.

Clause 13: The method of any of clauses 10 and 11, wherein sending the one or more notifications comprises sending the one or more notifications as part of a callback event initiated through an extension of the service description.

Clause 14: A device for retrieving media data, the device comprising one or more means for performing the method of any of clauses 1-13.

Clause 15: The device of clause 14, wherein the one or more means comprise a memory configured to store media data and a processing system comprising one or more processors.

Clause 16: The device of clause 14, wherein the device comprises at least one of: an integrated circuit; a microprocessor; or a wireless communication device.

Clause 17: A device for retrieving media data, the device comprising: means for receiving a service description including configuration information including one or more of data representing an abandon request rule (ABR) strategy, a buffer configuration, gap handling, or scheduling; means for configuring a media streaming application for playback and operation according to the configuration information of the service description; and means for using the configured media streaming application to retrieve media data.

Clause 18: A computer-readable storage medium having stored thereon instructions that, when executed, cause a processor to perform the method of any of clauses 1-13.

Clause 19: A method of retrieving media data, the method comprising: receiving an event message of a media presentation, the event message activating a service description for the media presentation, the service description including data representing how the media presentation is to be consumed, including one or more of a service latency for the media presentation, a playback rate for the media presentation, an operating quality for the media presentation, an operating bandwidth for the media presentation, content steering for the media presentation, or a metadata reporting configuration for the media presentation; receiving media data of the media presentation; and in response to receiving the event message of the media presentation activating the service description, presenting the media data according to the service description.

Clause 20: The method of clause 19, further comprising receiving a manifest file for the media presentation, the manifest file including data defining the service description and an identifier for the service description, wherein the event message includes the identifier for the service description to activate the service description.

Clause 21: The method of clause 19, wherein the event message includes data defining the service description.

Clause 22: The method of any of clauses 19-21, wherein the event message is included in an Event element of an EventStream element at a Period level of a manifest file for the media presentation.

Clause 23: The method of clause 22, wherein the manifest file comprises a Dynamic Adaptive Streaming over HTTP (DASH) media presentation description (MPD).

Clause 24: The method of any of clauses 19-23, wherein the event message includes data representing a media presentation time at which the service description is to be activated.

Clause 25: The method of any of clauses 19-24, wherein the event message includes data representing a duration of time for which the service description is to be activated.

Clause 26: The method of any of clauses 19-25, wherein the service description includes configuration information including one or more of data representing an abandon request rule (ABR) strategy, a buffer configuration, gap handling, or scheduling, the method further comprising: configuring a media streaming application for playback and operation according to the configuration information of the service description; and using the configured media streaming application to retrieve the media data of the media presentation.

Clause 27: The method of clause 26, wherein the event message includes callback information for sending a response from the media streaming application after applying the configuration information.

Clause 28: The method of any of clauses 19-27, further comprising, in response to receiving the event message: determining that the event message includes a new Event@id element; and determining a start time at which to activate the service description in response to the event message including the new Event@id element.

Clause 29: A device for retrieving media data, the device comprising: a memory configured to store media data of a media presentation; and a processing system comprising one or more processors implemented in circuitry and configured to: receive an event message of the media presentation, the event message activating a service description for the media presentation, the service description including data representing how the media presentation is to be consumed, including one or more of a service latency for the media presentation, a playback rate for the media presentation, an operating quality for the media presentation, an operating bandwidth for the media presentation, content steering for the media presentation, or a metadata reporting configuration for the media presentation; receive the media data of the media presentation; and in response to receiving the event message of the media presentation activating the service description, present the media data according to the service description.

Clause 30: The device of clause 29, wherein the processing system is further configured to receive a manifest file for the media presentation, the manifest file including data defining the service description and an identifier for the service description, wherein the event message includes the identifier for the service description to activate the service description.

Clause 31: The device of clause 29, wherein the event message includes data defining the service description.

Clause 32: The device of any of clauses 29-31, wherein the event message is included in an Event element of an EventStream element at a Period level of a manifest file for the media presentation.

Clause 33: The device of any of clauses 29-32, wherein the event message includes data representing a media presentation time at which the service description is to be activated.

Clause 34: The device of any of clauses 29-33, wherein the event message includes data representing a duration of time for which the service description is to be activated.

Clause 35: The device of any of clauses 29-34, wherein the service description includes configuration information including one or more of data representing an abandon request rule (ABR) strategy, a buffer configuration, gap handling, or scheduling, and wherein the processing system is further configured to: configure a media streaming application for playback and operation according to the configuration information of the service description; and use the configured media streaming application to retrieve the media data of the media presentation.

Clause 36: The device of clause 35, wherein the event message includes callback information for sending a response from the media streaming application after applying the configuration information.

Clause 37: The device of any of clauses 29-36, wherein the processing system is further configured to, in response to receiving the event message: determine that the event message includes a new Event@id element; and determine a start time at which to activate the service description in response to the event message including the new Event@id element.

Clause 38: A device for retrieving media data, the device comprising: means for receiving an event message of a media presentation, the event message activating a service description for the media presentation, the service description including data representing how the media presentation is to be consumed, including one or more of a service latency for the media presentation, a playback rate for the media presentation, an operating quality for the media presentation, an operating bandwidth for the media presentation, content steering for the media presentation, or a metadata reporting configuration for the media presentation; means for receiving media data of the media presentation; and means for presenting the media data according to the service description in response to receiving the event message of the media presentation activating the service description.

Clause 39: A computer-readable storage medium having stored thereon instructions that, when executed, cause a processor to perform the method of any of clauses 19-28.

Clause 40: A method of retrieving media data, the method comprising: receiving an event message of a media presentation, the event message including data representing a media presentation time at which a service description for the media presentation is to be activated; receiving media data of the media presentation; and in response to receiving the event message of the media presentation including the data representing the media presentation time at which the service description is to be activated, activating the service description at the media presentation time and presenting the media data according to the service description.

Clause 41: The method of clause 40, further comprising receiving a manifest file for the media presentation, the manifest file including data defining the service description and an identifier for the service description, wherein the event message includes the identifier for the service description to activate the service description.

Clause 42: The method of clause 40, wherein the event message includes data defining the service description.

Clause 43: The method of clause 40, wherein the event message is included in an Event element of an EventStream element at a Period level of a manifest file for the media presentation.

Clause 44: The method of clause 43, wherein the manifest file comprises a Dynamic Adaptive Streaming over HTTP (DASH) media presentation description (MPD).

Clause 45: The method of clause 40, wherein the service description includes data representing how the media presentation is to be consumed, including one or more of a service latency for the media presentation, a playback rate for the media presentation, an operating quality for the media presentation, an operating bandwidth for the media presentation, content steering for the media presentation, or a metadata reporting configuration for the media presentation.

Clause 46: The method of clause 40, wherein the event message includes data representing a duration of time for which the service description is to be activated.

Clause 47: The method of clause 40, wherein the service description includes configuration information including one or more of data representing an abandon request rule (ABR) strategy, a buffer configuration, gap handling, or scheduling, the method further comprising: configuring a media streaming application for playback and operation according to the configuration information of the service description; and using the configured media streaming application to retrieve the media data of the media presentation.

Clause 48: The method of clause 47, wherein the event message includes callback information for sending a response from the media streaming application after applying the configuration information.

Clause 49: The method of clause 40, further comprising, in response to receiving the event message: determining that the event message includes an Event@id element; and determining a start time at which to activate the service description in response to the event message including the Event@id element.

Clause 50: A device for retrieving media data, the device comprising: a memory configured to store media data of a media presentation; and a processing system comprising one or more processors implemented in circuitry and configured to: receive an event message of the media presentation, the event message including data representing a media presentation time at which a service description for the media presentation is to be activated; receive the media data of the media presentation; and in response to receiving the event message of the media presentation including the data representing the media presentation time at which the service description is to be activated, activate the service description at the media presentation time and present the media data according to the service description.

Clause 51: The device of clause 50, wherein the processing system is further configured to receive a manifest file for the media presentation, the manifest file including data defining the service description and an identifier for the service description, wherein the event message includes the identifier for the service description to activate the service description.

Clause 52: The device of clause 50, wherein the event message includes data defining the service description.

Clause 53: The device of clause 50, wherein the event message is included in an Event element of an EventStream element at a Period level of a manifest file for the media presentation.

Clause 54: The device of clause 50, wherein the service description includes data representing how the media presentation is to be consumed, including one or more of a service latency for the media presentation, a playback rate for the media presentation, an operating quality for the media presentation, an operating bandwidth for the media presentation, content steering for the media presentation, or a metadata reporting configuration for the media presentation.

Clause 55: The device of clause 50, wherein the event message includes data representing a duration of time for which the service description is to be activated.

Clause 56: The device of clause 50, wherein the service description includes configuration information including one or more of data representing an abandon request rule (ABR) strategy, a buffer configuration, gap handling, or scheduling, and wherein the processing system is further configured to: configure a media streaming application for playback and operation according to the configuration information of the service description; and use the configured media streaming application to retrieve the media data of the media presentation.

Clause 57: The device of clause 56, wherein the event message includes callback information for sending a response from the media streaming application after applying the configuration information.

Clause 58: The device of clause 50, wherein the processing system is further configured to, in response to receiving the event message: determine that the event message includes an Event@id element; and determine a start time at which to activate the service description in response to the event message including the Event@id element.

Clause 59: A device for retrieving media data, the device comprising: means for receiving an event message of a media presentation, the event message including data representing a media presentation time at which a service description for the media presentation is to be activated; means for receiving media data of the media presentation; and means for activating the service description at the media presentation time and means for presenting the media data according to the service description in response to receiving the event message including the data representing the media presentation time at which the service description is to be activated.

Clause 60: A method of sending media data, the method comprising: sending, to a client device, an event message of a media presentation, the event message including data representing a media presentation time at which a service description for the media presentation is to be activated; and sending, to the client device, media data of the media presentation.

Clause 61: The method of clause 60, further comprising sending, to the client device, a manifest file for the media presentation, the manifest file including data defining the service description and an identifier for the service description, wherein the event message includes the identifier for the service description to activate the service description.

Clause 62: The method of clause 60, wherein the event message includes data defining the service description.

Clause 63: The method of clause 60, wherein the event message is included in an Event element of an EventStream element at a Period level of a manifest file for the media presentation.

Clause 64: The method of clause 63, wherein the manifest file comprises a Dynamic Adaptive Streaming over HTTP (DASH) media presentation description (MPD).

Clause 65: The method of clause 60, wherein the service description includes data representing how the media presentation is to be consumed, including one or more of a service latency for the media presentation, a playback rate for the media presentation, an operating quality for the media presentation, an operating bandwidth for the media presentation, content steering for the media presentation, or a metadata reporting configuration for the media presentation.

Clause 66: The method of clause 60, wherein the event message includes data representing a duration of time for which the service description is to be activated.

Clause 67: The method of clause 60, wherein the service description includes configuration information including one or more of data representing an abandon request rule (ABR) strategy, a buffer configuration, gap handling, or scheduling.

Clause 68: The method of clause 67, wherein the event message includes callback information for receiving a response from a media streaming application of the client device after applying the configuration information.

Clause 69: The method of clause 60, wherein the event message includes an Event@id element comprising the data representing the media presentation time at which the service description is to be activated.

Clause 70: A device for sending media data, the device comprising: a memory configured to store media data of a media presentation; and a processing system comprising one or more processors implemented in circuitry, the processing system being configured to: send, to a client device, an event message of a media presentation, the event message including data representing a media presentation time at which a service description for the media presentation is to be activated; and send, to the client device, media data of the media presentation.

Clause 71: The device of clause 70, wherein the processing system is further configured to send, to the client device, a manifest file for the media presentation, the manifest file including data defining the service description and an identifier for the service description, wherein the event message includes the identifier for the service description to activate the service description.

Clause 72: The device of clause 70, wherein the event message includes data defining the service description.

Clause 73: The device of clause 70, wherein the event message is included in an Event element of an EventStream element at a Period level of a manifest file for the media presentation.

Clause 74: The device of clause 73, wherein the manifest file comprises a Dynamic Adaptive Streaming over HTTP (DASH) media presentation description (MPD).

Clause 75: The device of clause 70, wherein the service description includes data representing how the media presentation is to be consumed, including one or more of a service latency for the media presentation, a playback rate for the media presentation, an operating quality for the media presentation, an operating bandwidth for the media presentation, content steering for the media presentation, or a metadata reporting configuration for the media presentation.

Clause 76: The device of clause 70, wherein the event message includes data representing a duration of time for which the service description is to be activated.

Clause 77: The device of clause 70, wherein the service description includes configuration information including one or more of data representing an abandon request rule (ABR) strategy, a buffer configuration, gap handling, or scheduling.

Clause 78: The device of clause 77, wherein the event message includes callback information for receiving a response from a media streaming application of the client device after applying the configuration information.

Clause 79: The device of clause 70, wherein the event message includes an Event@id element comprising the data representing the media presentation time at which the service description is to be activated.

Clause 80: A device for sending media data, the device comprising: means for sending, to a client device, an event message of a media presentation, the event message including data representing a media presentation time at which a service description for the media presentation is to be activated; and means for sending, to the client device, media data of the media presentation.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code, and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. A method of retrieving media data, the method comprising:
receiving an event message of a media presentation, the event message including data representing a media presentation time at which a service description for the media presentation is to be activated;
receiving media data of the media presentation; and
in response to receiving the event message of the media presentation including the data representing the media presentation time at which the service description is to be activated, activating the service description at the media presentation time and presenting the media data according to the service description.

2. The method of claim 1, further comprising receiving a manifest file for the media presentation, the manifest file including data defining the service description and an identifier for the service description, wherein the event message includes the identifier for the service description to activate the service description.

3. The method of claim 1, wherein the event message includes data defining the service description.

4. The method of claim 1, wherein the event message is included in an Event element of an EventStream element at a Period level of a manifest file for the media presentation.

5. The method of claim 4, wherein the manifest file comprises a Dynamic Adaptive Streaming over HTTP (DASH) media presentation description (MPD).

6. The method of claim 1, wherein the service description includes data representing how the media presentation is to be consumed, including one or more of a service latency for the media presentation, a playback rate for the media presentation, an operating quality for the media presentation, an operating bandwidth for the media presentation, content steering for the media presentation, or a metadata reporting configuration for the media presentation.

7. The method of claim 1, wherein the event message includes data representing a duration of time for which the service description is to be activated.

8. The method of claim 1, wherein the service description includes configuration information including one or more of data representing an abandon request rule (ABR) strategy, a buffer configuration, gap handling, or scheduling, the method further comprising:
configuring a media streaming application for playback and operation according to the configuration information of the service description; and
using the configured media streaming application to retrieve the media data of the media presentation.

9. The method of claim 8, wherein the event message includes callback information for sending a response from the media streaming application after applying the configuration information.

10. The method of claim 1, further comprising, in response to receiving the event message:
determining that the event message includes an Event@id element comprising the data representing the media presentation time at which the service description is to be activated; and
determining a start time at which to activate the service description in response to the event message including the Event@id element.

11. A device for retrieving media data, the device comprising:
a memory configured to store media data of a media presentation; and
a processing system comprising one or more processors implemented in circuitry, the processing system being configured to:
receive an event message of the media presentation, the event message including data representing a media presentation time at which a service description for the media presentation is to be activated;
receive the media data of the media presentation; and
in response to receiving the event message of the media presentation including the data representing the media presentation time at which the service description is to be activated, activate the service description at the media presentation time and present the media data according to the service description.

12. The device of claim 11, wherein the processing system is further configured to receive a manifest file for the media presentation, the manifest file including data defining the service description and an identifier for the service description, wherein the event message includes the identifier for the service description to activate the service description.

13. The device of claim 11, wherein the event message includes data defining the service description.

14. The device of claim 11, wherein the event message is included in an Event element of an EventStream element at a Period level of a manifest file for the media presentation.

15. The device of claim 11, wherein the service description includes data representing how the media presentation is to be consumed, including one or more of a service latency for the media presentation, a playback rate for the media presentation, an operating quality for the media presentation, an operating bandwidth for the media presentation, content steering for the media presentation, or a metadata reporting configuration for the media presentation.

16. The device of claim 11, wherein the event message includes data representing a duration of time for which the service description is to be activated.

17. The device of claim 11, wherein the service description includes configuration information including one or more of data representing an abandon request rule (ABR) strategy, a buffer configuration, gap handling, or scheduling, and wherein the processing system is further configured to:
configure a media streaming application for playback and operation according to the configuration information of the service description; and
use the configured media streaming application to retrieve the media data of the media presentation.

18. The device of claim 17, wherein the event message includes callback information for sending a response from the media streaming application after applying the configuration information.

19. The device of claim 11, wherein the processing system is further configured to, in response to receiving the event message:
determine that the event message includes an Event@id element comprising the data representing the media presentation time at which the service description is to be activated; and
determine a start time at which to activate the service description in response to the event message including the Event@id element.

20. A device for retrieving media data, the device comprising:
means for receiving an event message of a media presentation, the event message including data representing a media presentation time at which a service description for the media presentation is to be activated;
means for receiving media data of the media presentation; and
means for activating the service description at the media presentation time and means for presenting the media data according to the service description in response to receiving the event message including the data representing the media presentation time at which the service description is to be activated.
